(19) United States
(12) Patent Application Publication
(10) Pub. No.: US 2011/0267803 A1
(43) Pub. Date: Nov. 3, 2011

(54) Apparatus and Method for Creating an Irrigation System Light Show

(76) Inventor: Trent Charles Farrer, Gresham, OR (US)

(21) Appl. No.: 13/097,160

(22) Filed: Apr. 29, 2011

Related U.S. Application Data
(60) Provisional application No. 61/329,675, filed on Apr. 30, 2010.

(51) Int. Cl. F21V 33/00

(52) U.S. Cl. 362/96

(57) ABSTRACT

An illumination system for use in new and existing sprinkler systems utilizes one or more LEDs in a sprinkler head to emit a beam of light into a stream of water flowing from the head. The LEDs may be powered from a variety of power sources, and a control system is operable to control the LED operation and the water flow through the system.

### FIELD OF THE INVENTION

This invention relates to an apparatus and method for creating an irrigation system light show, and more particularly to numerous styles of irrigation system components—primarily different types and styles of sprinkler heads—that have been fitted with illumination equipment, especially in the form of light emitting diodes of various colors, intensities, etc. The LEDS are associated with the sprinkler heads and shine light, intermittently or continuously or in predetermined patterns, into and through the water sprayed from the sprinkler heads.

### BACKGROUND

It is popular to illuminate water features such as fountains with lighting, and particularly with lights of various colors and intensities. For example, large fountains in entertainment centers such as those found in Las Vegas often include lights that illuminate the water jets that define the fountains. On a smaller scale basis, many residences have water features that are illuminated in one way or another. Many homeowners find the combination of water and light to produce a desirable effect.

Given the desire for the combination of water with light, there is an ongoing market for illuminated water features.

The present invention combines controlled illumination with sprinkler systems to achieve the ability to create a perfect beam of bright light of any color that is directed along or against the water stream created by the nozzle of a sprinkler head. Any commercial or residential built in sprinkler system is suitable for use with the invention. The invention utilizes a sprinkler head fitted one or more very bright energy efficient LEDs and may be powered with a variety of power sources, including solar power, battery power, or a combination of both. Hard wiring to grid power is another alternative. A controller is operable to control the lighting and sprinkler system.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a typical residential lawn irrigation system in which the illumination system of the present invention is incorporated into plural sprinkler heads.

FIG. 2 is a plan view of a representative controller for use with the present invention.

FIG. 3 is a perspective view of a solar photovoltaic panel for use with the present invention.

FIGS. 4, 5 and 6 illustrate three different embodiments of popup sprinkler heads that are fitted with LEDs according to the present invention.

FIG. 4 is a perspective view of a popup head that includes plural LEDs arranged around the body of the sprinkler to direct the light upwardly, and one or more LEDs near the nozzle at the top of the body.

FIG. 5 is a perspective view of a popup head having plural LEDs arranged around the body of the sprinkler, but further includes one or more LEDs near the nozzle.

FIG. 6 is a perspective view of a sprinkler in which an LED and a reflector are located near the nozzle at the top of the sprinkler body.

FIG. 7 is a perspective view of a conventional impact sprinkler head that has been equipped with an LED according to the present invention

FIG. 8 is a top plan view of an illumination cap according to the present invention that may be retrofitted onto a conventional popup sprinkler head.

FIG. 9 is a side elevation view of a conventional popup sprinkler head onto which an illumination cap according to the present invention has been adapted.

FIG. 10 is a top perspective view of the popup sprinkler shown in FIG. 9 with the popup sprinkler shown in the operational position that exists when water is flowing from the sprinkler.

FIG. 11 a top perspective view of the popup sprinkler head of FIG. 10, with the popup sprinkler shown in the resting position that exists when no water is flowing through the sprinkler.

FIG. 12 is a side elevation view of the illumination cap according to the present invention shown in isolation.

FIG. 13 is a top perspective view of the illumination cap according to the present invention.

FIG. 14 is a bottom plan view of the illumination cap shown in FIGS. 12 and 13.

FIG. 15 is a cross sectional view of the illumination cap shown in FIG. 12, taken along the line A-A of FIG. 12.

### DETAILED DESCRIPTION OF ILLUSTRATED EMBODIMENTS

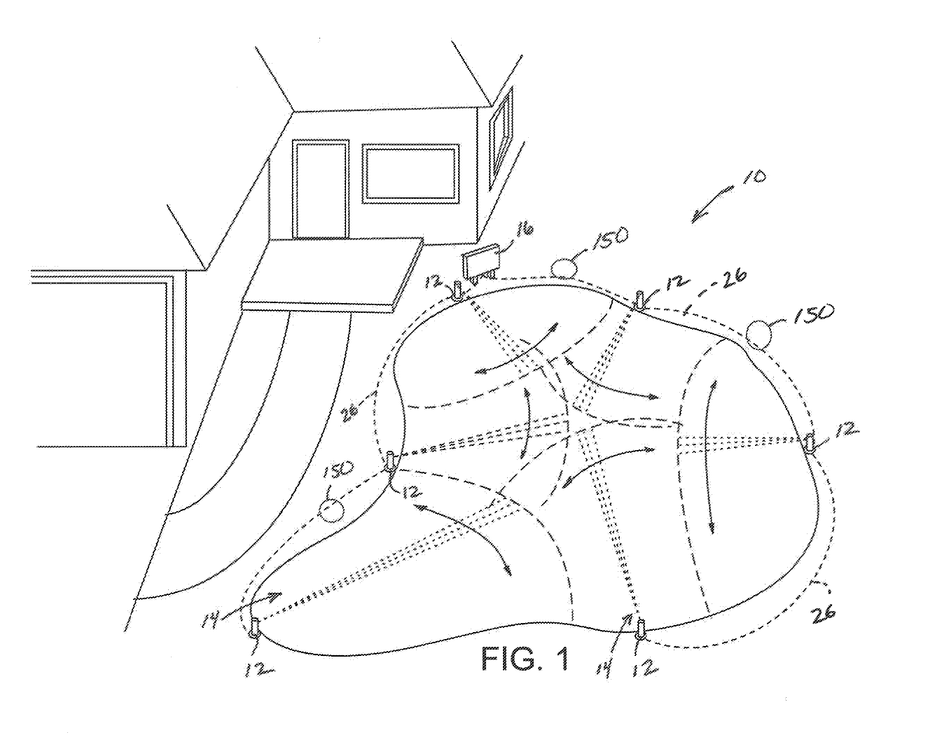

With reference now to FIG. 1, the illuminated sprinkler system 10 according to the present invention includes several different components, each of which is detailed herein. Specifically, system 10 included plural sprinkler heads 12, each of which is fitted with an illumination system shown generally at 14. FIG. 1 illustrates a typical installation of a residential, in-ground irrigation system that incorporates the illuminated sprinkler system 10 according to the present invention. The system 10 shown in FIG. 1 has six separate sprinkler heads 12, which in the illustration are typical “popup” type sprinkler heads. As detailed below, the illumination system 14 is defined by LEDs that are adapted to the sprinkler heads 12. The LEDs may be the same or different colors, and each sprinkler head 12 may be fitted with plural LEDs, which again may be the same or different colors. The sprinkler heads 12 are each wired to a control panel 16 that is configured for operation of the LEDs in predetermined patterns, sequences, etc., and each sprinkler head 12 may optionally be fitted with a pressure-sensitive switch as described below.

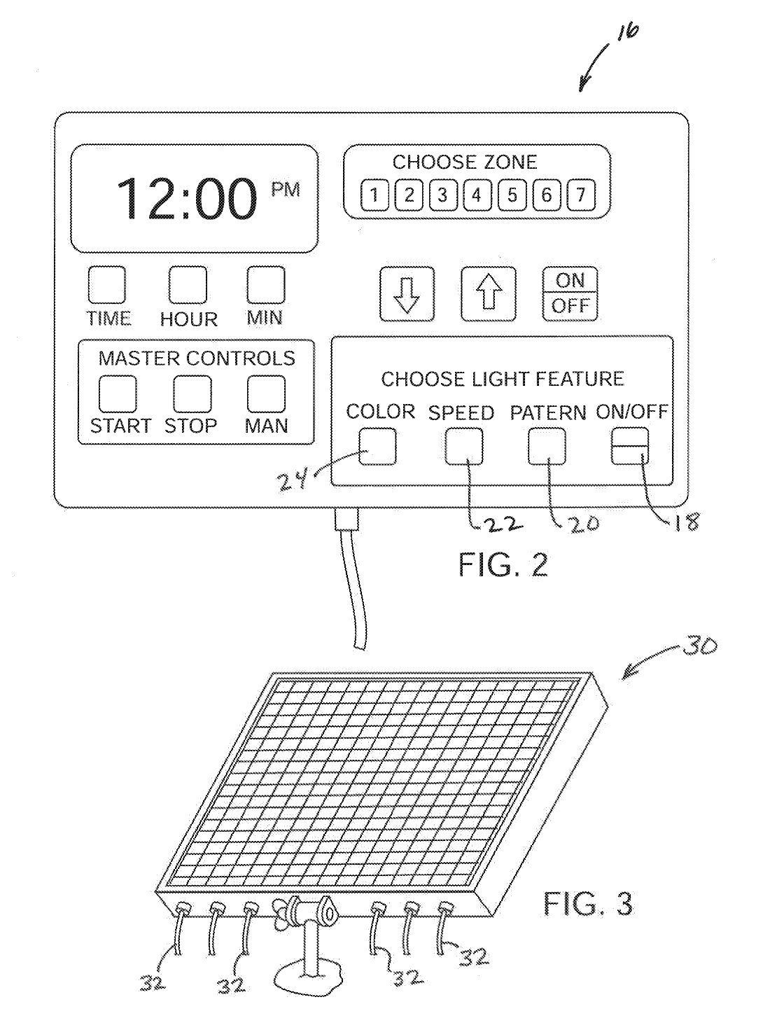

The control panel 16 is shown in detail in FIG. 2. It includes the standard control functions for controlling water flow through plural sprinkler heads, which typically are contained in multiple watering “zones.” But the control panel 16 for use with the present invention further includes controls for operating the light features defined by the LEDs contained in the sprinkler heads 12. Specifically, the control panel 16 includes operational controls for turning the LEDs on/off 18, controlling the pattern of illumination 20, the speed of the illumination (for example, intermittent illumination) 22, and the color of the illumination 24. It will be appreciated that the control panel 16 includes conventional processors for providing operational functionality for system 10. Returning to FIG. 1, low voltage power wires 26 extend from the control panel 16 to each of the illuminated sprinkler heads 12 to provide power to the LEDs in the heads.

The present invention contemplates that the control panel 16 for the illuminated sprinkler system 10 will have settings that will allow for light control, for example, coordination with music, strobe, illuminating lights of different color in predetermined sequences and patterns and timing, and essentially any control patter that would change the lighting effect.

The control panel 16 is powered in any number of ways, and the LEDs in the sprinkler heads 12 are likewise powered in any number of ways. In a first preferred embodiment, a solar panel 30 that is defined by photovoltaic cells is used for its ability to generate enough power to fully power all of the LEDs and the control panel 16. Depending upon the number of LEDs in a given system, this typically would require a solar panel 30 having a dimension of around two feet by eighteen inches. The solar panel would preferably have plural power jacks, as shown in FIG. 3 with the plural wiring leads 32, each of which is a low voltage lead running to an individual sprinkler head 12.

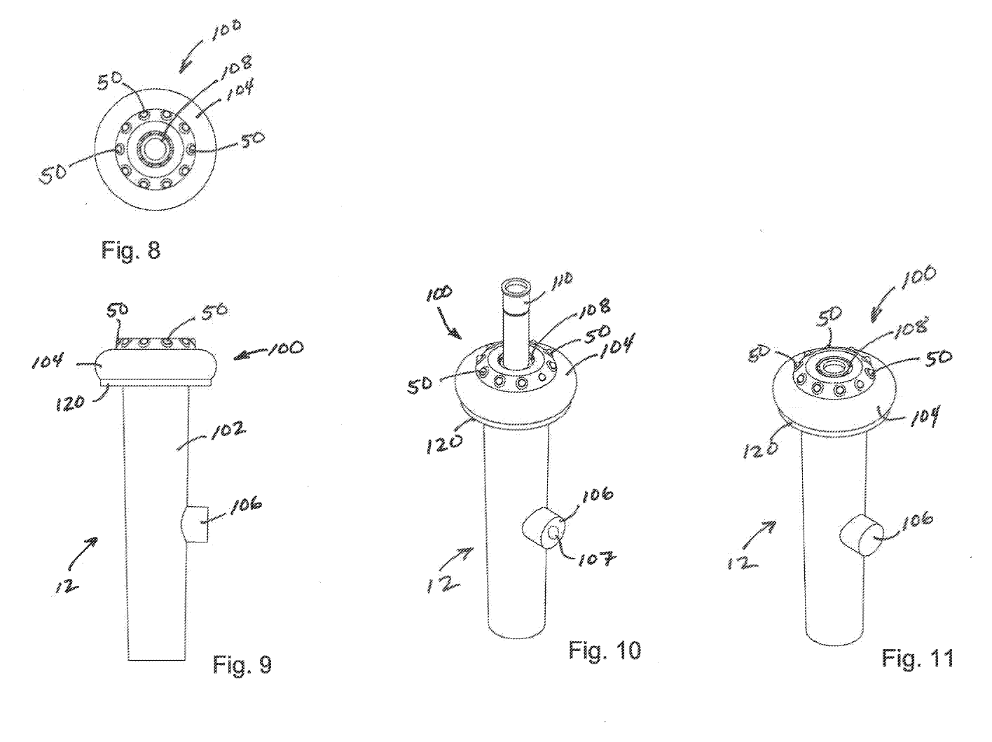

The system 10 according to the present invention could also be powered with a lithium battery that is slowly charged by the solar panel 30. Alternately, as detailed below in reference to the embodiments shown in FIGS. 8 through 16, each illuminated sprinkler head 12 may have LEDs that are powered by a battery contained in the sprinkler head. In addition, a sprinkler head's LED could have its own built-in solar panel that charges a replaceable battery located in the body of the sprinkler.

The illuminated sprinkler system 10 is installed just like every other irrigation system, but when placing the illuminated sprinkler heads 12 in the ground, a trench would be placed in a preselected location in the landscape so the solar panel 30 is placed for optimal charging. As noted above, each illuminated sprinkler head 12 in a system 10 is electrically connected to the power source, either directly to the solar panel or through an intermediate controller such as control panel 16. The sprinkler heads 12 having the LEDs would be installed in the conventional manner, including burying the heads in predetermined locations and adjusting them for maximum water coverage. After the stream is adjusted the light beam is adjusted as desired, generally for maximum light to water coverage.

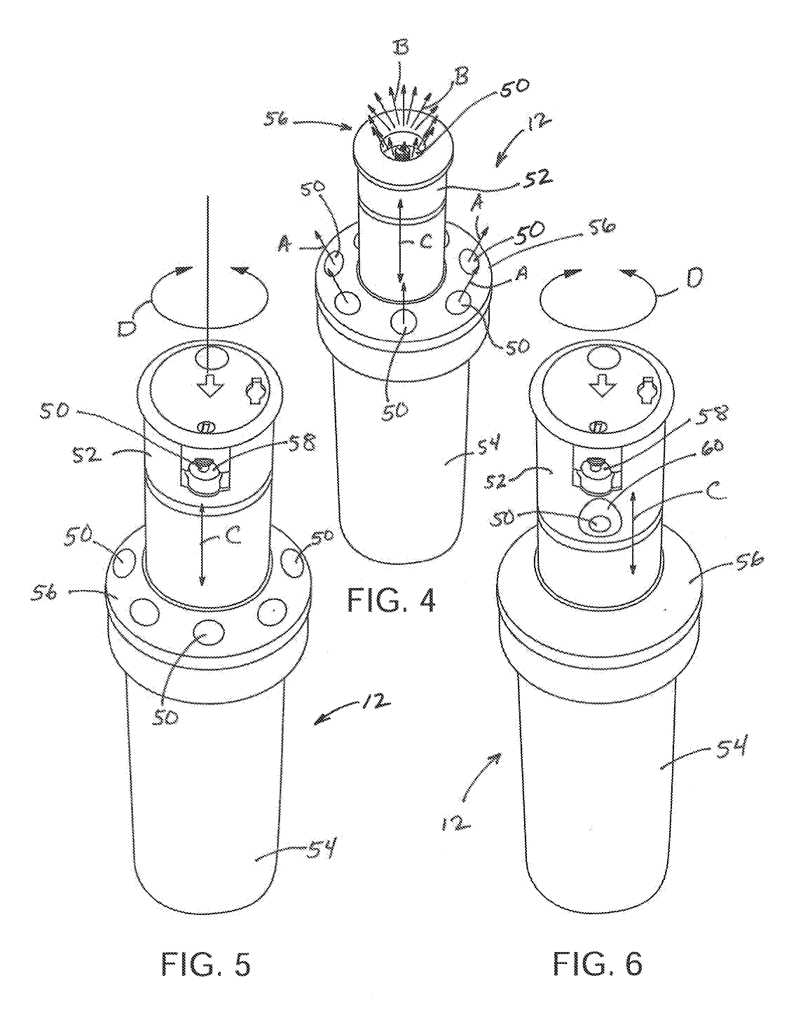

Reference is now made to FIG. 4, which shows a first illustrated embodiment of an illuminated sprinkler head 12 according to the present invention. The sprinkler head 12 shown in FIG. 4 is a popup-type head, which is shown with the popup shaft 52 in the extended position that exists when water is flowing through the head 12. These types of sprinkler heads emit a fan-shaped pattern of water out of the top of the head, and are often called “fixed spray heads.” When water is not flowing through head 12, the popup shaft 12 is withdrawn into the lower body portion 54 as shown with arrow C. Illuminated sprinkler head 12 of FIG. 4 includes plural LEDs 50 arranged around the body of the head at a shoulder portion 56. Each of the LEDs 50 is arranged so that it directs, emits the light upwardly as shown with arrows A. Sprinkler head 12 further includes one or more LEDs 50 near the nozzle 56 at the top of the popup shaft 52, which also are arranged to emit the light upwardly as shown with arrows B.

Water flowing from sprinkler head 12 is emitted from nozzle 56 in a generally upward direction, similar to the direction shown with arrows B. Because the light from LEDs 50 is also emitted in the same direction, the light is shown through the streams of water along the same general path. This causes each shaft of water to be illuminated by light from one or more LEDs. When LEDs of different colors are used, the streams of water may be illuminated in different colors.

The illuminated sprinkler head 12 of FIG. 5 is also a popup head type, with a lower portion 54 and a popup shaft 52, but the head 12 in FIG. 5 is of the type that emits a single stream of water out of nozzle orifice 58—the head rotates around its longitudinal axis as shown in arrow D as water is emitted out of a nozzle in orifice 58. In addition the LEDs 50 mounted in shoulder portion 56, a single LED 50 is mounted in nozzle orifice 58 so that light emitted from the LED 50 illuminates the stream of water flowing from the nozzle.

The illuminated sprinkler head 12 shown in FIG. 6 is of the same type as shown in FIG. 5, but omits the LEDs 50 mounted on shoulder portion 56 but includes an LED 50 mounted in the popup shaft 52 immediately below the nozzle orifice 58, and includes reflector 60 around the LED 50. The beam path of light emitted from LED 50 is generally the same as the path of the stream of water flowing from the nozzle in orifice 58.

In a preferred embodiment, and as especially illustrated in FIG. 6, each LED 50 is preferably supplied with a specially engineered reflective system around the light, such as reflector 60 in FIG. 6, which concentrates the beam perfectly in relation to the stream of water—for example, along the length of the stream of water or at angles with respect to the direction of the stream. Different types of sprinkler heads require a different type of reflector—each reflector is designed for the specific sprinkler head and for the specific installation. However, each reflector is built with the same principles in mind, namely, to focus the beam of light in the desired direction and intensity.

There are numerous types of LEDs commercially available that will work well with the present invention. Generally, the LEDs selected should have high intensity and be energy efficient. The invention contemplates LEDs of a variety of different colors in order to provide chosen effects. A single sprinkler head 12 may be fitted with one or more LEDs, and with LEDs of different colors.

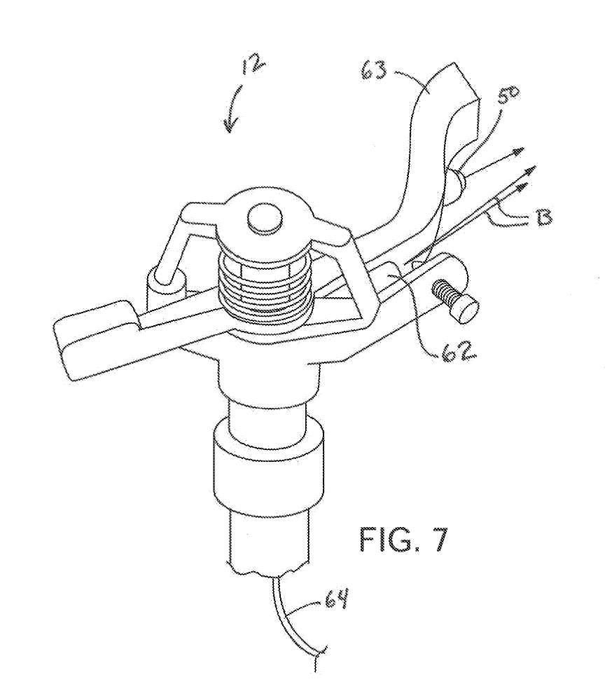

Turning now to FIG. 7, the illuminated sprinkler head 12 is a conventional impact type of sprinkler head that has been adapted to incorporate an LED 50 that emits a beam of light (arrow A) that is directed along the stream of water (arrows B) that flows from nozzle 62. The LED 50 is powered in any of the manners detailed above, and in the example of FIG. 7 a low voltage power wire 64 is shown leading into the body of the sprinkler head.

With respect to portable head such as the older-style “can” sprinkler heads, also known as “impact” heads (FIG. 7), when the sprinkler is active an arm flaps back and forth on the stream to interrupt the stream coverage. When the sprinkler cycles and the head returns to the original position the arm 63 flaps relatively more rapidly, sending water droplets over a wide distribution zone for maximum coverage. When the sprinkler arm is flapping back and forth in the slower direction, the LED 50 according to the present invention will only engage when the arm makes contact with the water stream, thereby to create the effect of frozen water. For the other direction, the returning direction in which the arm is flapping at a relatively more rapid rate, the LED will illuminate like a strobe also creating a freezing water effect, but as in a fast strobe. As with in-ground sprinkler heads such as popup heads, the LED may be powered by batteries, a solar panel or power supplied from the control panel.

FIGS. 8 through 15 illustrate another preferred embodiment of an illumination system adapted for use with irrigation sprinkler heads, and more particularly, an illumination cap 100 that is configured to be retrofitted onto existing sprinkler heads. As shown in FIGS. 8 and 9, illumination cap 100 is a round cap member 104 that is sized to fit on top of an existing sprinkler head 102, which as shown includes a water inlet 106. As detailed below with reference to other figures, cap 100 has a central opening 108 that opens to the popup shaft of the sprinkler head 102, and which allows the popup shaft to reciprocate out of, and back into, the body of the head in normal operations. Illumination cap 100 includes plural LEDs 50 arranges around the periphery of the cap at evenly spaced intervals, and such that a beam of light emitted from the LED is emitted in a generally upward direction (the same direction as water flowing from the sprinkler head).

As best seen in FIG. 10, the popup shaft 110 is operable to extend from the resting position (FIG. 9) that exists when water is not flowing through the sprinkler head 12, through opening 108 in illumination cap 100 and into the operational position shown in FIG. 10, which is the position of the sprinkler head when water is flowing through it.

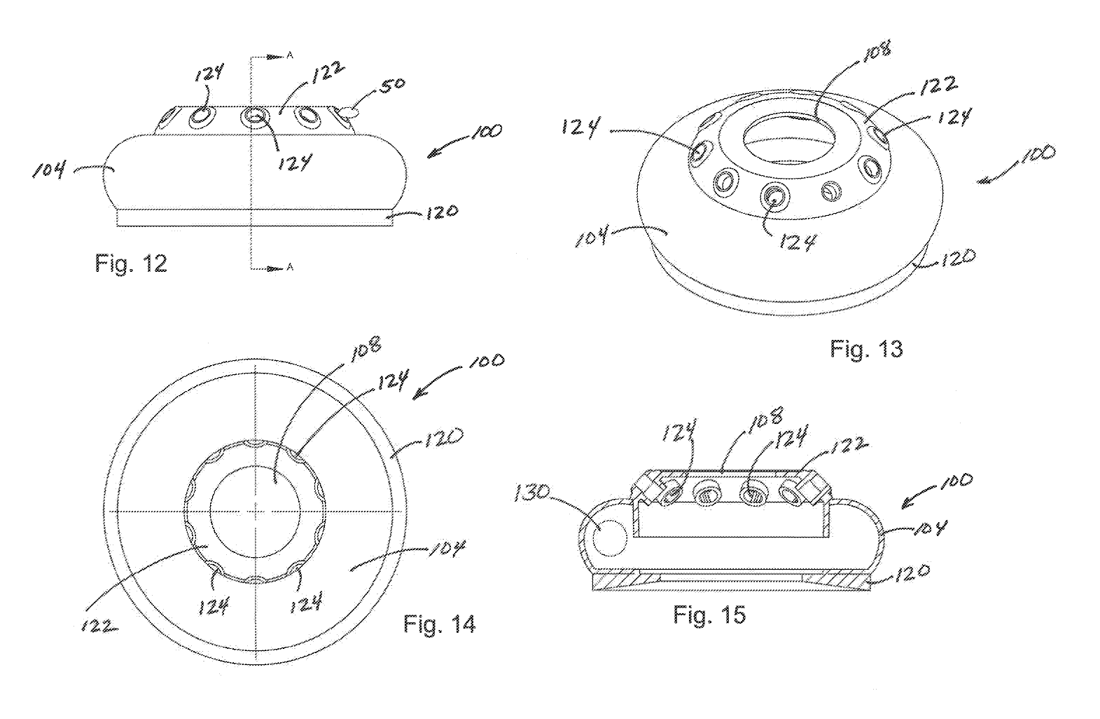

Illumination cap 100 is shown in isolation in FIGS. 12 through 15. The cap is a round member preferably fabricated from resilient plastic that includes a base 120, an LED retaining portion 122 having plural openings 124 each of which retains LEDs 50 (one of which is shown schematically in FIG. 12), and as noted previously, a central opening 108 through which popup shaft 110 reciprocates during operation of the sprinkler.

Illumination cap 100 is sized such that base 120 fits onto an existing body of a sprinkler head 12. Since there are numerous styles and makes of sprinkler heads 12 on the market, the base 120 may take on any number of different shapes, but regardless of the particular shape, the base preferably snaps onto the existing sprinkler head and is retained in place thereon. For example, some commercially available sprinkler heads have a circumferential lip at the top of shoulder of the head. An illumination cap 100 is sized and designed so that the base 120 is defined by a resilient lip or ring that is slightly smaller than the circumferential lip on the body of the sprinkler head, thereby allowing the cap 100 to snap onto the existing head. It will be appreciated therefore that cap 100 is configured to be, in one instance, retrofitted onto existing systems.

The LEDs 50 in illumination cap 100 may be powered in any of the manners previously described. In addition, when the cap 100 is retrofitted onto existing sprinkler heads 12, the LEDs may be powered by a battery 130 that is contained within the interior of the cap itself, as shown in FIG. 15 and which is electrically connected to the LEDs. When battery 130 is depleted of power, the cap 100 is removed and the battery the water flowpath (such as inlet 106). The switch is electrically connected between the power source and the LEDs and which is operable to power the LEDs when the switch is closed (i.e., when water is flowing through the flowpath) and depower the LEDs when the switch is open (i.e., when no water is flowing through the flowpath).

There are numerous configurations for placing the LEDs 50, with associated reflectors 60 when used, in the sprinkler heads 12. One preferred method to create a desired effect of light shining into and through water emitted from the sprinkler is to place all LEDs and reflectors below the nozzle on the sprinkler head. This allows light from each LED to shine into and be reflected from all droplets and follow the arching stream of water, producing a desirable effect. The beam of light emitted from each LED is concentrated (with LED placement and the reflector) into the stream of water. This concentration of emitted light directly into the stream of water enhances the light effect on the stream, and further diminishes emission of light from the LED other than where it is intended—i.e., into the water stream. This minimizes stray light that could be a nuisance to neighbors, drivers passing by and the like. Moreover, if the light emitted from the LEDs is concentrated and aimed properly into the water stream, all droplets of water take a sparkling appearance and tend to look like lights falling from the air.

The color of the LEDs both within a single sprinkler head and in adjacent heads may be varied as desired. Moreover, the illumination sequence of LEDs both within a single head and in adjacent heads may be controlled by a controller so that the illumination is timed. For example, the on-off illumination of lights may be controlled to coordinate with the beat of music. Also, the illumination from an LED or more than one LEDs may be a regular on/off pattern to provide a strobe effect to create the effect of freezing the water in mid air.

The direction that a beam of light is emitted may further be varied by providing an adjustment screw that varies the angle that the beam is emitted from the sprinkler head. The adjustment screw allows the light emitted from the LED to move into and out of the water stream and thereby accounts for the adjustment on the nozzle for water streams. The invention contemplates that different stream adjustments require different light adjustments and the adjustment screw provides variability in the adjustment of the light beam.

As noted, each sprinkler head may be fitted with a pressure-sensitive on/off switch 107 that is sensitive to water pressure, shown schematically in FIG. 10 in water inlet 106. The switch 107 is situated so that when water is flowing through the nozzle (i.e., when the sprinkler is on), the switch 107 will be in the closed position so that the LEDs are powered. When water flow through the nozzle stops, the switch is in the open position to depower the LEDs 50 and thus turn them off.

The invention contemplates use of LEDs in both in-ground sprinkler heads, and portable heads.

With reference again to FIG. 1, as an alternative embodiment, one or more lawn lights 150 are provided to light up the yard while the sprinkler system is running. The lawn light is an illumination source such as an LED or other light source that is embedded into a natural feature that would be found in landscaping, such as a natural rock, fence post and the like, or concealed in the ground adjacent to and/or between sprinkler heads. The lawn lights 150 are wired to each other and connected to a control panel 16, which as noted previously includes a timer and power source. The timer is synchronized to the sprinkler system's Run time. This allows the timer to power the lights at the same time as water begins to flow through the sprinklers. The lawn lights 150 provide a similar effect to the sprinkler lights detailed above.

While the present invention has been described in terms of a preferred embodiment, it will be appreciated by one of ordinary skill that the spirit and scope of the invention is not limited to those embodiments, but extend to the various modifications and equivalents as defined in the appended claims.

1. An illumination system for an irrigation sprinkler, comprising
at least one sprinkler head adapted for attachment to a source of fluid so that a stream of fluid may be sprayed from a nozzle in the sprinkler head;
an illumination source attached to the sprinkler head such that light from the illumination source is directed onto a stream of water flowing from the nozzle.

2. The illumination system according to claim 1 in which the illumination source is defined by at least one LED, wherein the LED is attached to the sprinkler head such that a beam of light emitted from the LED is directed onto the stream of water.

3. The illumination system according to claim 2 including plural LEDs arranged around the nozzle, each LED directing a beam of light onto the stream of water.

4. The illumination system according to claim 3 wherein the sprinkler head is defined by a sprinkler body and a popup head that reciprocates out of and into the sprinkler body between an operational position in which water is flowing through the nozzle, and a resting position in which no water is flowing through the nozzle, and wherein the plural LEDs are arranged around the popup head on a shoulder portion of the sprinkler body.

5. The illumination system according to claim 4 wherein the nozzle is located on the popup head and including at least one LED mounted on the popup head adjacent the nozzle.

6. The illumination system according to claim 3 in which the plural LEDs are attached to an illumination cap adapted for attachment to a body of the sprinkler head, said illumination cap having a central opening through which a popup head is movable between an extended position in which water is flowing through the nozzle and the popup head is extended away from the body of the sprinkler head, and a retracted position in which no water is flowing through the nozzle and the popup head is contained within the body of the sprinkler head, and wherein the plural LEDs are arranged around the central opening.

7. The illumination system according to claim 6 wherein the illumination cap includes retainer means for attaching the illumination cap to the body of the sprinkler head.

8. The illumination system according to claim 7 in which the retainer means is defined by a resilient lip on the illumination cap that snaps onto a cooperatively shaped edge on the sprinkler body.

9. The illumination system according to claim 6 wherein water flows into the sprinkler head in a fluid flow path, and including a switch in the fluid flow pathway, said switch activated by water and operable to power the LEDs when water is flowing through the flow path and to depower the LEDs when water is not flowing through the flow path.

10. The illumination system according to claim 6 including a battery contained in the illumination cap and electrically connected to the LEDs.

11. An illumination system for an irrigation sprinkler, comprising:
a sprinkler head having a body and a nozzle adapted for emitting a stream of water therefrom, and
an illumination source attached to the body and configured for emitting a beam of light onto a stream of water emitted from the nozzle.

12. The illumination system according to claim 11 including a reflector associated with the illumination source to focus the beam of light on the stream of water.

13. The illumination system according to claim 12 including a power source for powering the illumination source.

14. The illumination system according to claim 13 including plural sprinkler heads and plural illumination sources, and a controller for illuminating the illumination sources according to predetermined patterns and times.

15. An illumination system for a sprinkler having a main body and a popup head having a nozzle thereon, the popup head movable between an extended position in which water is flowing through a flowpath through the nozzle and in which the popup head extended away from the main body, and a retracted position in which no water is flowing through the nozzle and in which the popup head is contained within the main body of the sprinkler, comprising:
a cap adapted for attachment to the main body of the sprinkler, the cap having an opening through a central portion thereof through which the popup head is movable between the extended and retracted positions, and plural LEDs arranged around the opening and oriented in the cap to emit light onto water flowing through the nozzle.

16. The illumination system according to claim 15 including a power source attached to the plural LEDs.

17. The illumination system according to claim 16 wherein the power source is a battery contained in the cap.

18. The illumination system according to claim 17 including a switch in the flowpath, said switch operable by water flowing through the flow path to power the LEDs when water is flowing through the flowpath and operable to depower the LEDs when water is not flowing through the flowpath.

19. The illumination system according to claim 16 including a control system operable to control flow of water through the flowpath and to control operation of the LEDs.

20. The illumination system according to claim 19 wherein the plural LEDs comprise different colors.
